(19) United States
(12) Patent Application Publication
(10) Pub. No.: US 2005/0141761 A1
(43) Pub. Date: Jun. 30, 2005

(54) Method and apparatus for measuring dimensions of a pattern on a semiconductor device

(76) Inventors: Jin-Woo Lee, Sungnam-si (KR); Sang-Kil Lee, Suwon-si (KR); Byung-Am Lee, Suwon-si (KR); Yong-Wan Kim, Yongin-si (KR); Hyo-Sang Cho, Yongin-si (KR); Byung-Seol Ahn, Suwon-si (KR)

Correspondence Address: HARNESS, DICKEY & PIERCE, P.L.C., P.O. BOX 8910, RESTON, VA, 20195, US

(21) Appl. No.: 11/022,775

(22) Filed: Dec. 28, 2004

(30) Foreign Application Priority Data
Dec. 29, 2003 (KR) 2003-98501

(51) Int. Cl. G06K 9/00

(52) U.S. Cl. 382/145

(57) ABSTRACT

An apparatus and method for measuring a dimension of a pattern on a semiconductor device are provided. The method may include at least overlapping a reference pattern with an actual pattern that may be formed on a substrate, comparing the actual pattern with the reference pattern to determine whether the actual pattern may be aligned with the reference pattern, moving the actual pattern or the reference pattern in accordance with the results of the comparison to align the actual pattern with the reference pattern, and measuring a dimension of the actual pattern.

### CROSS REFERENCE TO RELATED APPLICATION

This U.S. non-provisional application claims priority under 35 USC § 119 to Korean Patent Application No. 2003-98501, filed on Dec. 29, 2003, in the Korean Intellectual Property Office, the contents of which are herein incorporated by reference in their entirety.

### BACKGROUND OF THE INVENTION

1. Field of the Invention

Exemplary embodiments of the present invention relate to a method and apparatus for measuring a dimension of a pattern that may be formed on a semiconductor device. More particularly, exemplary embodiments of the present invention relate to a method and apparatus for measuring a critical dimension (CD) of a reduced pattern on a semiconductor substrate.

2. Description of the Related Arts

Generally, a semiconductor device may be manufactured by forming a layer on a semiconductor substrate and then patterning the layer to form a pattern. The pattern may have characteristics in accordance with characteristics of a semiconductor device. For example, the pattern may have CDs in accordance with a design pattern of the semiconductor device. To determine whether the pattern may match with the designed pattern, processes for manufacturing a semiconductor device may include a process for measuring critical dimensions of the pattern.

Accordingly, an apparatus for measuring a CD may include a scanning electron microscope (SEM). During a method of measuring a CD using the SEM, electron beams may be irradiated onto a pattern formed on a semiconductor substrate, and secondary electrons may be emitted from the pattern. Further, signals of the secondary electrons may be converted into image signals so that the CD of the pattern may be measured based on the image signals.

The SEM may also include an electron gun for generating the electron beams. The electron beams generated from the electron gun may be focused through at least a condensing lens, an eccentric coil, an objective lens, and a shutter in sequence. The focused electron beams may be irradiated onto the semiconductor substrate. A detector may detect the secondary electrons emitted from the semiconductor substrate. An amplifier may then amplify the detected signals of the secondary electrons. The amplified signals may be transmitted onto a fluorescent face of, for example, a cathode-ray tube to form the image of the pattern.

The semiconductor substrate may be loaded into the SEM. The semiconductor substrate may then be aligned. The SEM may address a position of the semiconductor substrate on which the CD is measured. The SEM may also recognize an actual pattern of the semiconductor substrate. Recognizing the actual pattern in the SEM may be carried out through, for example, overlapping a reference pattern that may be previously set in the SEM with the actual pattern. Accordingly, the CD of the actual pattern may be measured using the above-mentioned method. After measuring the CD of the actual pattern, the semiconductor substrate may be unloaded from the SEM.

When the reference pattern is overlapped with the actual pattern, the actual pattern may not be matched with the reference pattern. For example, the actual pattern may be slightly mis-aligned with the reference pattern. Because the SEM fails to recognize the actual pattern, the SEM may be suspended until reset. As a result, downtime of the SEM may be increased.

If the SEM recognizes that the actual pattern is mis-aligned with the reference pattern, the SEM may measure other CD position different from the desired position. As a result, the SEM may output an error data different from a desired data. The error data may force the SEM to determine the actual pattern having the CD within designed ranges that may be abnormal and/or to determine the actual pattern having the CD beyond the designed ranges that may be normal.

To overcome the above problems, a conventional approach of measuring a CD of a pattern may be illustrated by the flowchart of FIG. 1.

Referring to FIG. 1, in ST1, a SEM may output a first position signal. In ST2, a stage may be moved to align a semiconductor substrate. In ST3, the SEM may be set to a low magnification condition. In ST4, a low magnification image data may be obtained. In ST5, a low magnification edge segment data may be obtained from the low magnification image data. In ST6, a CAD segment data may be obtained from the low magnification image data. In ST7, two images of the edge segment data and the CAD segment data may be matched with each other to measure any mis-matched distance. In ST8, the stage may be moved in accordance with a second position signal corresponding to the mis-matched distance.

According to the above-mentioned conventional method, the segment data corresponding to an actual pattern and the CAD segment data corresponding to a reference pattern may overlap with each other. The actual pattern may then be moved in accordance with the mis-matched distances so that the SEM may recognize the actual pattern.

However, because the actual pattern may only be recognized using one reference pattern, the conventional method may not be employed in measuring actual patterns having different CDs in accordance with various processing conditions. Particularly, actual patterns formed on a semiconductor substrate may have slightly different CDs in accordance with the variations of the processing conditions. When the actual patterns having different CDs are recognized using only one reference pattern, the SEM may often fail to recognize the actual pattern.

### SUMMARY OF THE INVENTION

In an exemplary embodiment, a method of measuring a dimension of a pattern on a semiconductor device may include at least overlapping a reference pattern with an actual pattern that may be formed on a substrate, comparing the actual pattern with the reference pattern to determine whether the actual pattern may be aligned with the reference pattern, moving the actual pattern or the reference pattern in accordance with the results of the comparison to align the actual pattern with the reference pattern, and measuring the dimension of the actual pattern.

In other exemplary embodiments, prior to overlapping the reference pattern with the actual pattern, the method may further include setting preliminary reference patterns with different dimensions, sequentially comparing the preliminary reference patterns with the actual pattern, selecting the reference pattern among the preliminary reference patterns having the dimension corresponding to that of the actual pattern, and recognizing the actual pattern based on the selected reference pattern.

In other exemplary embodiments, the preliminary reference patterns may include shapes substantially similar to the actual pattern.

In yet other exemplary embodiments, the preliminary reference patterns may include a main reference pattern and auxiliary reference patterns, the auxiliary reference patterns being larger or smaller than the main reference pattern.

In other exemplary embodiments, the method may further include addressing a position on the substrate to be measured after recognizing the actual pattern.

In yet other exemplary embodiments, measuring the dimension of the actual pattern may further include irradiating an electron beam onto the actual pattern, detecting secondary electrons emitted from the actual pattern, obtaining an image signal corresponding to the dimension of the actual pattern from the detected secondary electrons and measuring the dimension of the actual pattern based on the image signal.

In other exemplary embodiments, a method of measuring a dimension of a pattern on a semiconductor device may include at least setting preliminary reference patterns having different dimensions, comparing the preliminary reference patterns with an actual pattern, selecting a reference pattern among the preliminary reference patterns having the dimension corresponding to the actual pattern, recognizing the actual pattern based on the selected reference pattern, overlapping the reference pattern with the actual pattern, comparing the actual pattern with the reference pattern to determine whether the actual pattern is aligned with the reference pattern, moving the actual pattern or the reference pattern in accordance with the results of the comparison to align the actual pattern with the reference pattern and measuring the dimension of the actual pattern.

In other exemplary embodiments, an apparatus for measuring a dimension of a pattern on a semiconductor device may include at least a comparator for comparing an actual pattern with a reference pattern to determine whether the actual pattern may be aligned with the reference pattern, a controller for moving the actual pattern or the reference pattern to align the actual pattern with the reference pattern in accordance with a comparison result of the comparator, and a measuring unit for measuring the dimension of the actual pattern in accordance with a signal from the controller.

In other exemplary embodiments, the comparator may further overlap the actual pattern, which is on the substrate, with the reference pattern that has a shape corresponding to that of the actual pattern.

In other exemplary embodiments, the reference pattern may include a plurality of preliminary reference patterns having shape substantially similar to that of the actual pattern.

In other exemplary embodiments, the apparatus may further include a matching unit for comparing the preliminary reference patterns with the actual pattern to select the reference pattern among the preliminary reference patterns having a dimension which correspond to that of the actual pattern.

In other exemplary embodiments, the controller may recognize the actual pattern based on the selected reference pattern.

In other exemplary embodiments, the comparator may transmit a mis-alignment signal to the controller so as to align the actual pattern with the reference pattern.

In other exemplary embodiments, the measuring unit may include a scanning electron microscope.

In yet other exemplary embodiments, the scanning electron microscope may include at least an electron gun, a condensing lens, a first eccentric coil, an objective lens, and a shutter.

In yet other exemplary embodiments, the electron gun may generate a condensed electron beam. The condensed electron beam may be focused through the first eccentric coil, the objective lens and an aperture in the shutter.

In yet other exemplary embodiments, the focused electron beam may be irradiated onto a substrate.

In other exemplary embodiments, the apparatus may further include at least a detector to detect secondary electrons emitting from the actual pattern on the substrate, an amplifier for amplifying a signal from the detector, the amplified signal may be transmitted to a cathode-ray tube through a second eccentric coil to form an image corresponding to the actual pattern on the cathode-ray tube, and a control circuit to control the first and second eccentric coils to properly alter an angle of the electron beam.

In other exemplary embodiments, an apparatus for measuring a dimension of a pattern on a semiconductor device may include at least a matching unit for comparing preliminary reference patterns with an actual pattern to select a reference pattern among the preliminary reference patterns whose dimension will correspond to that of the actual pattern, a comparator for comparing the actual pattern with the selected reference pattern to determine whether the actual pattern may be aligned with the selected reference pattern, a controller for moving the actual pattern or the selected reference pattern to align the actual pattern with the selected reference pattern in accordance with a comparison result of the comparator, and a measuring unit for measuring the dimension of the actual pattern in accordance with a signal from the controller.

In other exemplary embodiments, the present invention may provide a method and apparatus of measuring a critical dimension of a pattern on a semiconductor device that may be capable of accurately recognizing actual patterns having different critical dimensions.

### BRIEF DESCRIPTION OF THE DRAWINGS

Exemplary embodiments of the present invention will be readily understood with reference to the following detailed description thereof provided in conjunction with the attached drawings in which:

FIG. 1 is a flow chart illustrating a conventional method of measuring a critical dimension of a pattern on a semiconductor device;

FIG. 2 is a block diagram illustrating an exemplary embodiment of an apparatus for measuring a critical dimension of a pattern on a semiconductor device in accordance with the present invention;

FIG. 3 is a perspective view illustrating an exemplary embodiment of a measuring apparatus;

FIG. 4 is a flow chart illustrating an exemplary embodiment of a method of measuring a critical dimension of a pattern on a semiconductor device using the apparatus of FIG. 2;

FIG. 5 is a plan view illustrating an exemplary embodiment of operations of sequentially matching a reference pattern with an actual pattern;

FIG. 6 is a plan view illustrating an exemplary embodiment of a reference pattern;

FIG. 7 is a plan view illustrating an exemplary embodiment of an actual pattern;

FIG. 8 is a plan view illustrating an exemplary embodiment of operations of aligning the reference pattern with the actual pattern;

FIG. 9 is a block diagram illustrating another exemplary embodiment of an apparatus for measuring a critical dimension of a pattern on a semiconductor device in accordance with the present invention; and

FIG. 10 is a flow chart illustrating an exemplary embodiment of a method of measuring a critical dimension of a pattern on a semiconductor device using the apparatus of FIG. 9.

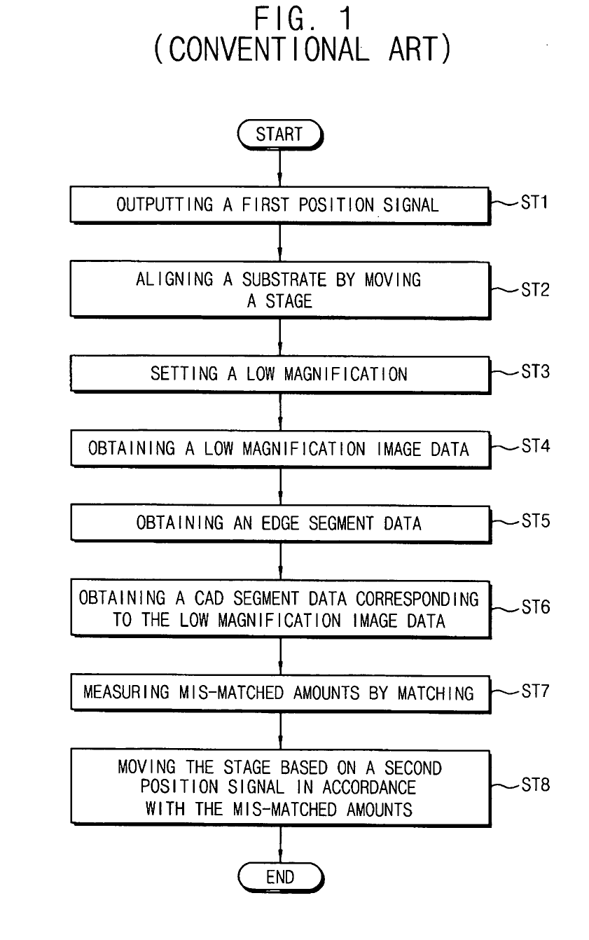

### DETAILED DESCRIPTION OF EXEMPLARY EMBODIMENTS

Exemplary embodiments of the present invention will now be described more fully hereinafter with reference to the accompanying drawings, in which exemplary embodiments of the invention are shown. However, it should be appreciated that the invention may be embodied in many different forms and should not be construed as being limited to the embodiments set forth herein; rather, the exemplary embodiments are provided so that this disclosure will be thorough and complete, and will fully convey the concept of the invention to those skilled in the art. Throughout the specification, the same reference numerals in different drawings may represent the same element.

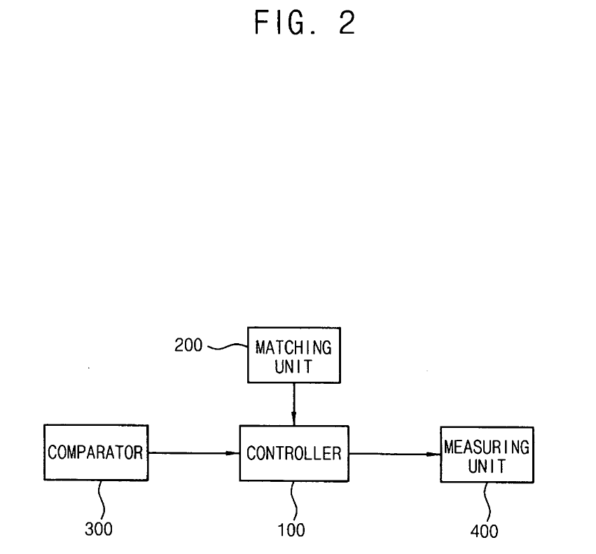

FIG. 2 is a block diagram illustrating an exemplary embodiment of an apparatus for measuring a critical dimension of a pattern on a semiconductor device in accordance with the present invention.

Referring to FIG. 2, an apparatus for measuring a critical dimension (CD) of a pattern on a semiconductor device may include at least a controller 100, a matching unit 200, a comparator 300, and a measuring unit 400.

The controller 100 may control the entire operation of the apparatus. Inputted into the controller 100 may be a main reference pattern RP0. The main reference pattern RP0 may have a shape substantially similar to that of an actual pattern AP that may be formed on a semiconductor substrate. A first auxiliary reference pattern RP1, a second auxiliary reference pattern RP2, a third auxiliary reference pattern RP3, a fourth auxiliary reference pattern RP4, and a fifth auxiliary reference pattern RP5 may also be inputted into the controller 100. Further, the main reference pattern RP0, the first, second, third, fourth, and fifth auxiliary reference patterns RP1, RP2, RP3, RP4, and RP5, respectively, may correspond to preliminary reference patterns. The first, second, third, fourth, and fifth auxiliary reference patterns RP1, RP2, RP3, RP4, and RP5, respectively, may have shapes substantially similar to that of the main reference pattern RP0. As an exemplary embodiment, when the main reference pattern RP0 has, for example, but not limited to, a shape of a cross, the first, second, third, fourth, and fifth auxiliary reference patterns RP1, RP2, RP3, RP4, and RP5 may also have a shape of a cross that may be larger or smaller than that of the main reference pattern RP0. It should be appreciated that other shapes may be employed to represent the pattern.

The matching unit 200 may sequentially compare the main reference pattern RP0, the first, second, third, fourth, and fifth auxiliary reference patterns RP1, RP2, RP3, RP4, and RP5, respectively, with an actual pattern AP. When the main reference pattern RP0 has a shape substantially similar to that of the actual pattern AP, the matching unit 200 may select the main reference pattern RP0 as a reference pattern RP. Alternatively, when the main reference pattern RP0 has a shape different from that of the actual pattern AP, the matching unit 200 may select any one of the first, second, third, fourth, and fifth auxiliary reference patterns RP1, RP2, RP3, RP4, and RP5, respectively, which may have a shape substantially similar to that of the actual pattern AP, which may act as the reference pattern RP. In an exemplary embodiment, the matching unit 200 may select the fifth auxiliary reference pattern RP5 as the reference pattern RP. The selected fifth auxiliary reference pattern RP5 may be set in the controller 100. The controller 100 may then recognize the actual pattern AP corresponding to the selected fifth auxiliary reference pattern RP5 as an object to be measured.

According to an exemplary embodiment, the first, second, third, fourth, and fifth auxiliary reference patterns RP1, RP2, RP3, RP4, and RP5, respectively, may be set in the controller 100. The controller 100 may recognize the actual pattern AP based on the reference pattern RP that has a shape substantially similar to that of the actual pattern AP. Therefore, recognizing the actual pattern AP by the controller 100 may be possible, even though the actual pattern AP may have a shape different from that of the main reference pattern RP0 due to variations of processing conditions. Accordingly, a method for measuring a CD may be continuously performed without resetting the apparatus.

The comparator 300 may overlap the selected reference pattern RP with the actual pattern AP to compare the reference pattern RP with the actual pattern AP. The comparator 300 may transmit a signal including the results of the comparison to the controller 100.

The controller 100 may move the reference pattern RP and/or the actual pattern AP in accordance with the signal transmitted from the comparator 300 so as to align the reference pattern RP with the actual pattern AP.

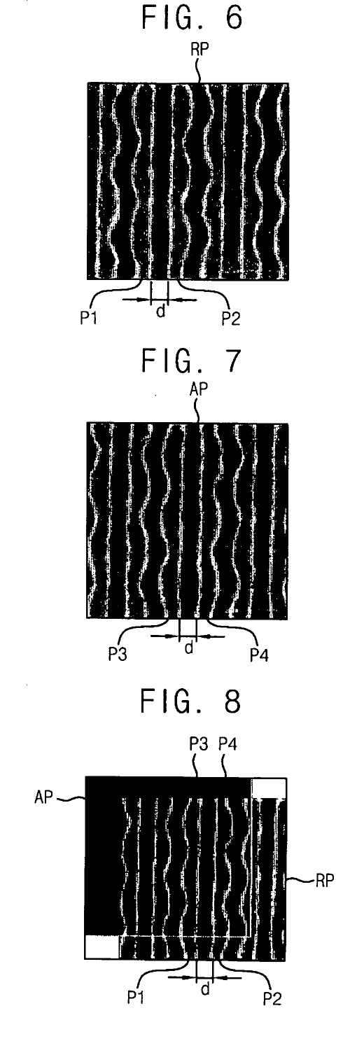

Referring to FIG. 6, the reference pattern RP may have first and second patterns P1 and P2, respectively, spaced apart from each other by a CD, designated as d. With reference to FIG. 7, the actual pattern AP may have third and fourth patterns P3 and P4, respectively, spaced apart from each other by the CD d. To measure the CD d of the actual pattern AP, accurately overlapping the first and second patterns P1 and P2 of the reference pattern RP with the third and fourth patterns P3 and P4 of the actual pattern AP may be required, respectively. However, the third and fourth patterns P3 and P4 of the actual pattern AP may be shifted in a direction (e.g., right) with respect to the first and second patterns P1 and P2 of the reference pattern RP. The comparator 300 may detect a mis-matched distance between the reference pattern RP and the actual pattern AP and then may transmit a signal including the mis-matched distance to the controller 100. With reference to FIG. 8, the controller 100 may move the reference pattern RP in a direction (e.g., right) and/or the actual pattern AP in a direction (e.g., left) to align the reference pattern RP with the actual pattern AP.

When the reference pattern RP is aligned with the actual pattern AP, the controller 100 may transmit a signal including a measuring signal to the measuring unit 400. The measuring unit 400 may measure the CD d of the actual pattern AP.

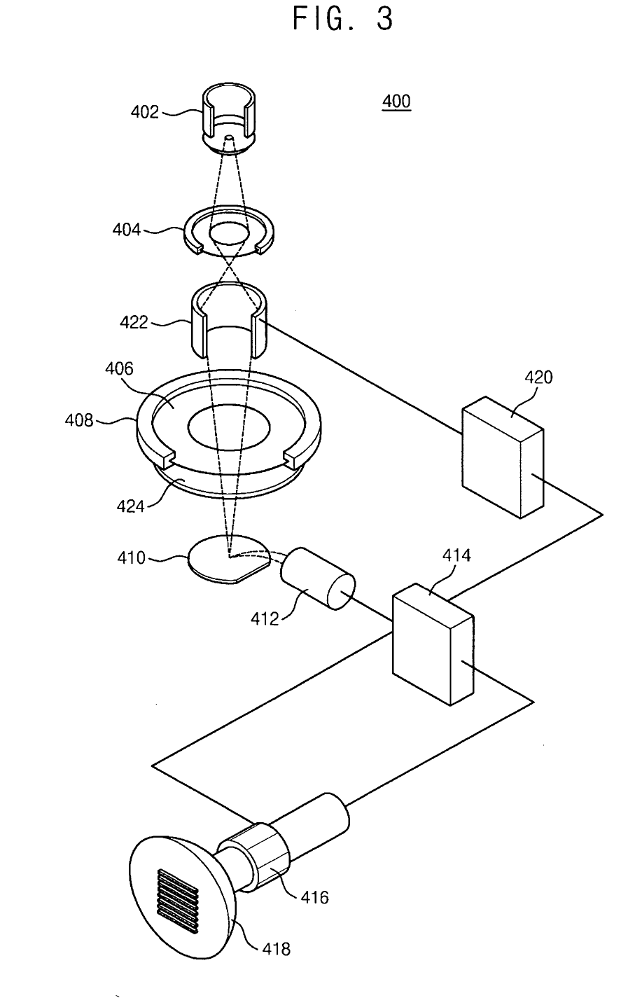

With reference to FIG. 3, the measuring unit 400 may include at least an electron gun 402, a condensing lens 404, a first eccentric coil 422, an objective lens 406, and a shutter 410 having an aperture 408. The above-mentioned elements may be disposed in a sequence from an upward direction to a downward direction over a semiconductor substrate (not shown). An electron beam generated from the electron gun 402 may be condensed through the condensing lens 404. The condensed electron beam may be focused through the first eccentric coil 422, the objective lens 406, and the aperture 408 of the shutter 410. The focused electron beam may be irradiated onto the semiconductor substrate, and the secondary electrons may be emitted from the actual pattern AP of the semiconductor substrate.

A detector 412 may detect the secondary electrons. An amplifier 414 may amplify a detection signal from the detector 412. The amplified signal may be transmitted to, for example, a cathode-ray tube 418 through a second eccentric coil 416 to form an image corresponding to the actual pattern AP on the cathode-ray tube 418. Further, a control circuit 420 may control the first and second eccentric coils 422 and 416, respectively to properly alter an angle of the electron beam.

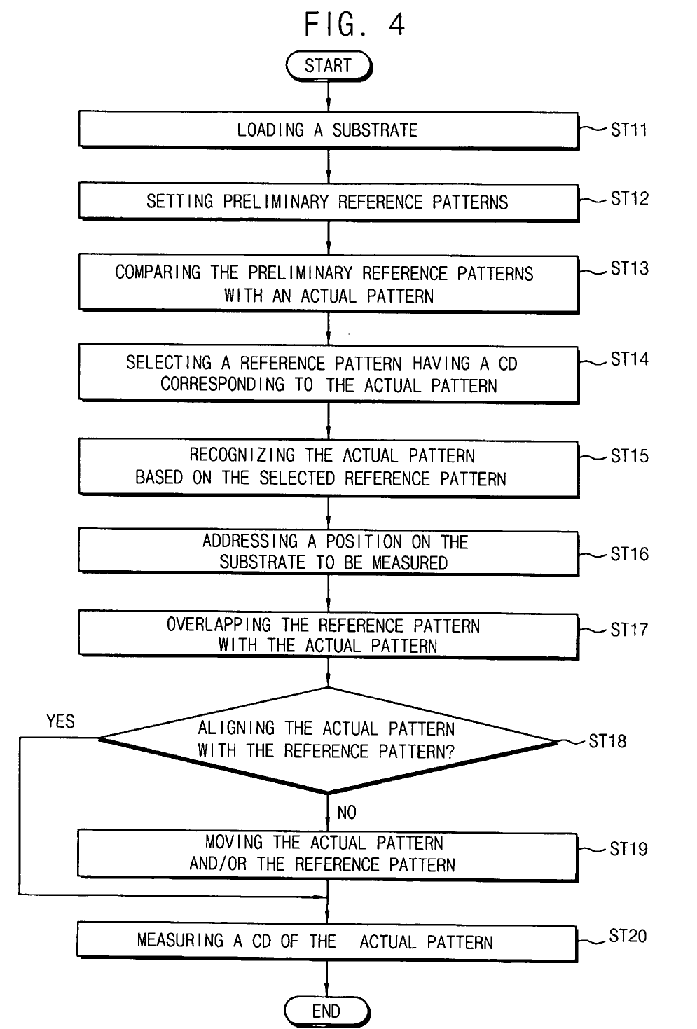

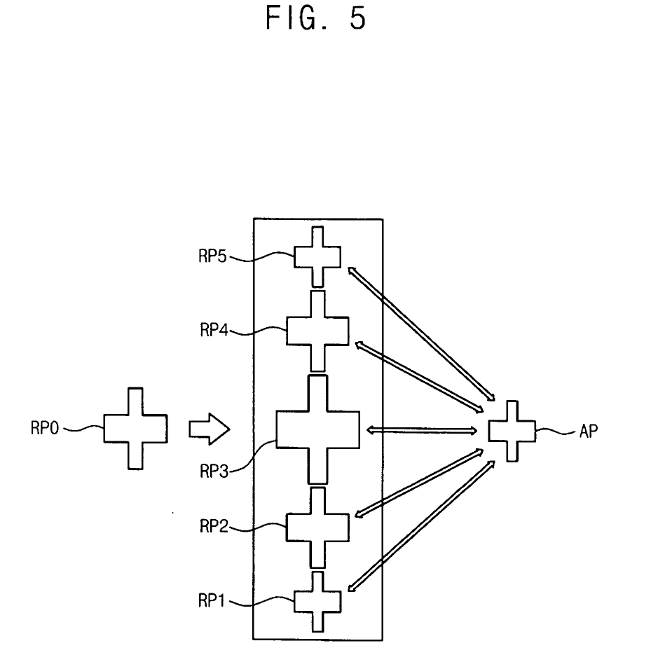

In accordance to an exemplary embodiment, a method of measuring a CD of a pattern on a semiconductor device using the apparatus of FIG. 2 is illustrated in detail with reference to FIG. 4.

Referring to FIG. 4, in ST11, the semiconductor substrate on which an actual pattern AP is formed may be loaded into the apparatus in FIG. 2. The semiconductor substrate may be disposed on a stage in the apparatus.

In ST12, the preliminary reference patterns RP0, RP1, RP2, RP3, RP4, and RP5 may be set in the controller 100. In the exemplary embodiment, the preliminary reference patterns RP0, RP1, RP2, RP3, RP4, and RP5 may have shapes substantially similar to that of the actual pattern AP.

In ST13, the matching unit 300 may sequentially compare the preliminary reference patterns RP0, RP1, RP2, RP3, RP4, and RP5 with the actual pattern AP.

In ST14, the matching unit 300 may select one of the preliminary reference patterns RP0, RP1, RP2, RP3, RP4, and RP5, which may have a shape substantially similar to that of the actual pattern AP and act as the reference pattern RP. In the exemplary embodiment, the fifth reference pattern RP5 may be selected as the reference pattern RP. The selected fifth reference pattern RP5 may be set in the controller 100.

In ST15, the controller 100 may recognize the actual pattern having the shape corresponding to the fifth reference pattern RP5 as the object to be measured for a CD. Particularly, since the controller 100 may have information concerning the fifth reference pattern RP5, the controller 100 may recognize the actual pattern AP in accordance with the information.

In ST16, a position on the semiconductor substrate to be measured for the CD may be addressed in the controller 100.

In ST17, the comparator 300 may overlap the fifth reference pattern RP5 with the actual pattern AP.

In ST18, the comparator 300 may compare the actual pattern AP with the fifth reference pattern RP5 to determine whether the actual pattern AP is aligned with the fifth reference pattern RP5.

In ST19, when the actual pattern AP is not aligned with the fifth reference pattern RP5, the comparator 300 may transmit a mis-alignment signal to the controller 100. Accordingly, the controller 100 may move the actual pattern AP and/or the fifth reference pattern RP5 in accordance with the mis-alignment signal to align the actual pattern AP with the fifth reference pattern RP5.

Alternatively, when the actual pattern AP is aligned with the fifth reference pattern RP5, the controller 100 may transmit a measurement signal to the measuring unit 400, in ST20. The measuring unit 400 may measure the CD of the actual pattern AP.

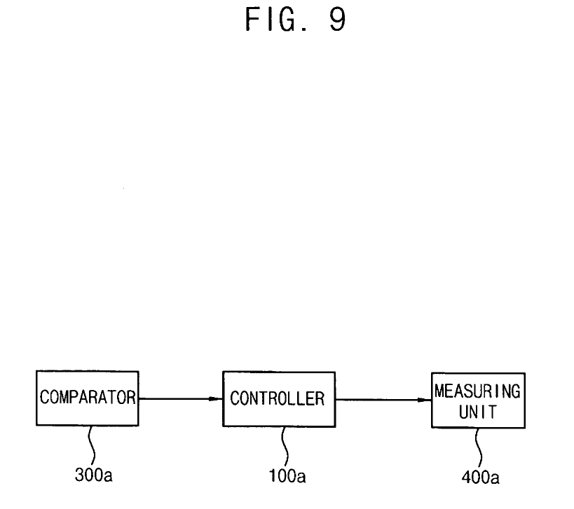

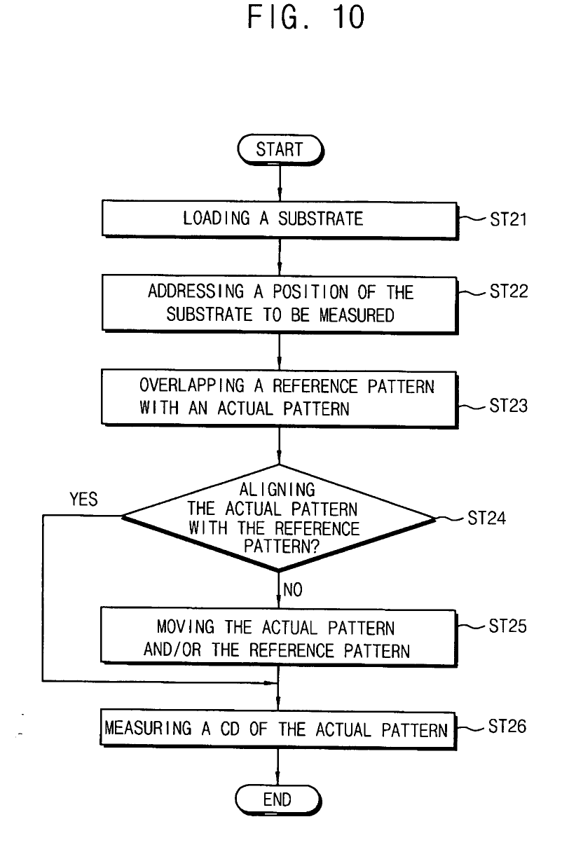

FIG. 9 is a block diagram illustrating another exemplary embodiment of an apparatus for measuring a critical dimension of a pattern on a semiconductor device in accordance with the present invention.

Referring to FIG. 9, an apparatus for measuring a CD of a pattern on a semiconductor device in accordance with the exemplary embodiment of the present invention may include at least a controller 100a, a comparator 300a, and a measuring unit 400a.

The controller 100a may control the entire operation of the apparatus. Inputted into the controller 100a may be a reference pattern RP having a shape corresponding to an actual pattern AP formed on a semiconductor substrate (not shown).

The comparator 300a may overlap the selected reference pattern RP with the actual pattern AP so as to compare the reference pattern RP with the actual pattern AP. The comparator 300a may also transmit a signal including the results of the comparison to the controller 100a.

The controller 100a may move the reference pattern RP and/or the actual pattern AP in accordance with the signal transmitted from the comparator 300a so as to align the reference pattern RP with the actual pattern AP.

When the reference pattern RP is aligned with the actual pattern AP, the controller 100a may transmit a measurement signal to the measuring unit 400a. The measuring unit 400a may measure a CD of the actual pattern AP.

In accordance to an exemplary embodiment, a method of measuring a CD of a pattern on a semiconductor device using the apparatus of FIG. 9 is illustrated in detail with reference to FIG. 10.

Referring to FIG. 10, in ST21, the semiconductor substrate on which the actual pattern AP may be formed is loaded into the apparatus in FIG. 9. The semiconductor substrate may be disposed on a stage in the apparatus.

In ST22, a position on the semiconductor substrate to be measured for the CD may be addressed in the controller 100a.

In ST23, the comparator 300a may overlap the reference pattern RP with the actual pattern AP.

In ST24, the comparator 300a may compare the actual pattern AP with the reference pattern RP to determine whether the actual pattern AP is aligned with the reference pattern RP.

In ST25, when the actual pattern AP is not aligned with the reference pattern RP, the comparator 300a may transmit a mis-alignment signal to the controller 100a. The controller 100a may move the actual pattern AP and/or the reference pattern RP in accordance with the mis-alignment signal to align the actual pattern AP with the reference pattern RP.

In ST26, the controller 100a may transmit a measurement signal to the measuring unit 400. The measuring unit 400a may measure the CD of the actual pattern AP.

According to the exemplary embodiments of the present invention, one pattern having a shape substantially similar to that of the actual pattern of the reference pattern may be selected and the actual pattern may be recognized based on the selected reference pattern. As a result, the apparatus of the present invention may accurately recognize the actual pattern on the substrate.

Further, the selected reference pattern may be compared to the actual pattern, and the actual pattern and/or the reference pattern may then be moved to align the actual pattern with the reference pattern. Therefore, the CD of the actual pattern aligned with the reference pattern may be measured so that the CD of a desired position on the actual pattern may be accurately measured and error data may not be outputted.

While the present invention has been particularly shown and described with reference to exemplary embodiments thereof, it should be understood by those of ordinary skill in the art that various changes in form and details may be made therein without departing from the spirit and scope of the invention as defined by the following claims.

1. A method of measuring a dimension of a pattern on a semiconductor device, comprising:
overlapping a reference pattern with an actual pattern that is formed on a substrate;
comparing the actual pattern with the reference pattern to determine whether the actual pattern is aligned with the reference pattern;
moving the actual pattern or the reference pattern in accordance with the results of the comparison to align the actual pattern with the reference pattern; and
measuring the dimension of the actual pattern.

2. The method of claim 1, wherein prior to overlapping the reference pattern with the actual pattern, the method further comprises:
setting preliminary reference patterns with different dimensions;
sequentially comparing the preliminary reference patterns with the actual pattern;
selecting the reference pattern among the preliminary reference patterns having a dimension corresponding to that of the actual pattern; and
recognizing the actual pattern based on the selected reference pattern.

3. The method of claim 2, wherein the preliminary reference patterns including shapes substantially similar to the actual pattern.

4. The method of claim 3, wherein the preliminary reference patterns including a main reference pattern and auxiliary reference patterns, the auxiliary reference patterns being larger or smaller than the main reference pattern.

5. The method of claim 2, further comprising addressing a position on the substrate to be measured after recognizing the actual pattern.

6. The method of claim 1, wherein measuring the dimension of the actual pattern further comprises:
irradiating an electron beam onto the actual pattern;
detecting secondary electrons emitted from the actual pattern;
obtaining an image signal corresponding to the dimension of the actual pattern from the detected secondary electrons; and
measuring the dimension of the actual pattern based on the image signal.

7. A method of measuring a dimension of a pattern on a semiconductor device, comprising:
setting preliminary reference patterns having different dimensions;
comparing the preliminary reference patterns with an actual pattern;
selecting a reference pattern among the preliminary reference patterns having the dimension corresponding to the actual pattern;
recognizing the actual pattern based on the selected reference pattern;
overlapping the reference pattern with the actual pattern;
comparing the actual pattern with the reference pattern to determine whether the actual pattern is aligned with the reference pattern;
moving the actual pattern or the reference pattern in accordance with the results of the comparison to align the actual pattern with the reference pattern; and
measuring the dimension of the actual pattern.

8. The method of claim 7, wherein the preliminary reference patterns including shapes substantially similar to the actual pattern.

9. The method of claim 8, wherein the preliminary reference patterns including a main reference pattern and auxiliary reference patterns, the auxiliary reference patterns being larger or smaller than the main reference pattern.

10. The method of claim 7, further comprising addressing a position on the substrate to be measured after recognizing the actual pattern.

11. The method of claim 7, wherein the measuring of the dimension of the actual pattern further comprises:
irradiating an electron beam onto the actual pattern;
detecting secondary electrons emitted from the actual pattern;
obtaining an image signal corresponding to the dimension of the actual pattern from the detected secondary electrons; and
measuring the dimension of the actual pattern based on the image signal.

12. A method of measuring a dimension of a pattern on a semiconductor device, comprising:
setting preliminary reference patterns having different dimensions;
sequentially comparing the preliminary reference patterns with an actual pattern;
selecting the reference pattern among the preliminary reference patterns having the dimension corresponding to that of the actual pattern;
recognizing the actual pattern based on the selected reference pattern;
overlapping the reference pattern with the actual pattern;
comparing the actual pattern with the reference pattern to determine whether the actual pattern is aligned with the reference pattern;
moving the actual pattern or the reference pattern in accordance with the results of the comparison to align the actual pattern with the reference pattern;
irradiating an electron beam onto the actual pattern;
detecting secondary electrons emitted from the actual pattern;
obtaining an image signal corresponding to the dimension of the actual pattern from the detected secondary electrons; and
measuring the dimension of the actual pattern based on the image signal.

13. The method of claim 12, wherein the preliminary reference patterns including shapes substantially similar to the actual pattern.

14. The method of claim 13, wherein the preliminary reference patterns including a main reference pattern and auxiliary reference patterns, the auxiliary reference patterns being larger or smaller than the main reference pattern.

15. The method of claim 12, further comprising addressing a position on the substrate to be measured, after recognizing the actual pattern.

16. An apparatus for measuring a dimension of a pattern on a semiconductor device, comprising:
a comparator for comparing an actual pattern with a reference pattern to determine whether the actual pattern is aligned with the reference pattern;
a controller for moving the actual pattern or the reference pattern to align the actual pattern with the reference pattern in accordance with a comparison result of the comparator; and
a measuring unit for measuring the dimension of the actual pattern in accordance with a signal from the controller.

17. The apparatus of claim 16, wherein the comparator overlaps the actual pattern, which is formed on a substrate, with the reference pattern that has a shape corresponding to that of the actual pattern.

18. The apparatus of claim 16, wherein the reference pattern includes a plurality of preliminary reference patterns having shape substantially similar to that of the actual pattern.

19. The apparatus of claim 18, further comprising a matching unit for comparing the preliminary reference patterns with the actual pattern to select the reference pattern among the preliminary reference patterns having a dimension which corresponds to that of the actual pattern.

20. The apparatus of claim 16, wherein the controller recognizes the actual pattern based on the selected reference pattern.

21. The apparatus of claim 16, wherein the comparator transmits a mis-alignment signal to the controller so as to align the actual pattern with the reference pattern.

22. The apparatus of claim 16, wherein the measuring unit includes a scanning electron microscope.

23. The apparatus of claim 22, wherein the scanning electron microscope includes an electron gun, a condensing lens, a first eccentric coil, an objective lens, and a shutter.

24. The apparatus of claim 23, wherein the electron gun generates a condensed electron beam, and the condensed electron beam is focused through the first eccentric coil, the objective lens and an aperture in the shutter.

25. The apparatus of claim 24, wherein the focused electron beam is irradiated onto a substrate.

26. The apparatus of claim 22, further comprising:
a detector to detect secondary electrons emitting from the actual pattern on the substrate;
an amplifier for amplifying a signal from the detector, the amplified signal is transmitted to a cathode-ray tube through a second eccentric coil to form an image corresponding to the actual pattern on the cathode-ray tube; and
a control circuit to control the first and second eccentric coils to properly alter an angle of the electron beam.

27. An apparatus for measuring a dimension of a pattern on a semiconductor device, comprising:
a matching unit for comparing preliminary reference patterns with an actual pattern to select a reference pattern among the preliminary reference patterns having a dimension which corresponds to that of the actual pattern;
a comparator for comparing the actual pattern with the selected reference pattern to determine whether the actual pattern is aligned with the selected reference pattern;
a controller for moving the actual pattern or the selected reference pattern to align the actual pattern with the selected reference pattern in accordance with a comparison result of the comparator; and
a measuring unit for measuring the dimension of the actual pattern in accordance with a signal from the controller.

28. The apparatus of claim 27, wherein the comparator further overlaps the actual pattern, which is formed on a substrate, with the reference pattern that has a shape corresponding to that of the actual pattern.

29. The apparatus of claim 27, wherein the selected reference pattern includes a plurality of preliminary reference patterns having shape substantially similar to that of the actual pattern.

30. The apparatus of claim 27, wherein the controller recognizes the actual pattern based on the selected reference pattern.

31. The apparatus of claim 27, wherein the comparator transmits a mis-alignment signal to the controller so as to align the actual pattern with the reference pattern.

32. An apparatus for measuring a dimension of a pattern on a semiconductor device according to the method of claim 1.

33. An apparatus for measuring a dimension of a pattern on a semiconductor device according to the method of claim 7.

34. An apparatus for measuring a dimension of a pattern on a semiconductor device according to the method of claim 12.
